(19) United States
(12) Patent Application Publication
(10) Pub. No.: US 2024/0129799 A1
(43) Pub. Date: Apr. 18, 2024

(54) INTER-DOMAIN OPERATION IN OPEN RADIO ACCESS NETWORKS

(71) Applicant: International Business Machines Corporation, Armonk, NY (US)

(72) Inventors: Maja Curic, Munich (DE); Sagar Tayal, Ambala City (IN); David Jason Hunt, Kirkwood, MO (US)

(21) Appl. No.: 18/045,844

(22) Filed: Oct. 12, 2022

(51) Int. Cl. H04W 28/08

(52) U.S. Cl. CPC H04W 28/0925; H04W 28/0812

(57) ABSTRACT

A computer-implemented method includes creating an awareness module on a first near-Real-Time RAN Intelligent Controller (near-RT RIC) that controls a first domain. The first near-RT RIC identifies a second near-RT RIC that controls a second domain, which has a mutual impact on the first domain. The first near-RT RIC creates a first border state that represents attributes of the first near-RT RIC and the xApps of the first near-RT RIC. The first near-RT RIC receives from the second near-RT RIC, a second border state of the second near-RT RIC. The first near-RT RI generates, a policy for the first near-RT RIC and the second near-RT RIC by analyzing the first and second border states. The first near-RT RIC updates a parameter only if the policy allows a requesting xApp to update the parameter.

### BACKGROUND

The present invention relates to computer technology, particularly to programmable networks and, even more specifically, to programmable radio access networks (RANs) that can use the open-RAN (O-RAN) network standards.

A RAN is a portion of a telecommunication system that typically connects user equipment (UE) devices, such as mobile phones, computers, or remotely controlled machines, and the telecommunication system's core network (CN). The RAN functionality is generally provided by hardware and/or software residing in a base station in proximity to a cell site. O-RAN refers to a disaggregated approach to deploying a RAN by using open and/or interoperable protocols and interfaces, which allows for increased flexibility over traditional RAN systems. O-RAN can be implemented with vendor-neutral hardware and software-defined technology based on open interfaces and industry-developed standards.

### SUMMARY

According to one or more embodiments of the present invention, a computer-implemented method for addressing cross-domain conflicts in a radio access network (RAN) is described. The computer-implemented method includes creating on a first near-Real-Time RAN Intelligent Controller (near-RT RIC) an awareness module comprising a plurality of instructions, the first near-RT RIC controls a first domain. The method further includes identifying, by the first near-RT RIC, a second near-RT RIC that controls a second domain, wherein an update request from one or more xApps being executed by the first near-RT RIC and the second near-RT RIC has a mutual impact on the first domain and the second domain. The method further includes creating, by the first near-RT RIC, a first border state that represents attributes of the first near-RT RIC and the one or more xApps being executed by the first near-RT RIC. The method further includes receiving, by the first near-RT RIC from the second near-RT RIC, a second border state that represents attributes of the second near-RT RIC and the one or more xApps being executed by the second near-RT RIC. The method further includes generating, by the first near-RT RIC, a policy for the first near-RT RIC and the second near-RT RIC by analyzing the first border state and the second border state. In response to receiving, by the first near-RT RIC, a request from an xApp from the one or more xApps to update a parameter of the RAN, the parameter is updated based on the policy allowing the xApp to update the parameter, alternatively, the parameter is maintained unchanged based on the policy restricting the xApp to update the parameter.

In one or more embodiments of the present invention, the awareness module is created on the near-RT RIC by a non-Real-Time RAN Intelligent Controller (non-RT RIC).

In one or more embodiments of the present invention, the first near-RT RIC generates the policy using machine learning.

In one or more embodiments of the present invention, the first near-RT RIC updates the first border state in response to each action taken by any of the one or more xApps.

In one or more embodiments of the present invention, the first near-RT RIC and the second near-RT RIC communicate with each other via a communication link without using the non-RT RIC.

In one or more embodiments of the present invention, the first near-RT RIC sends the policy to the second near-RT RIC to cause the second near-RT RIC, in response to the request from the xApp from the one or more xApps to update the parameter of the RAN: update the parameter based on the policy allowing the xApp to update the parameter; and maintain the parameter unchanged based on the policy restricting the xApp to update the parameter.

In one or more embodiments of the present invention, the policy is a first policy, and wherein second near-RT RIC compares the first policy with a second policy generated by the second near-RT RIC based on one or more of prioritization and criticality.

In one or more embodiments of the present invention, the method further includes receiving, by the first near-RT RIC, one or more operational intents that specify desired operating ranges for one or more performance indicators. The policy is generated based on the first border state, the second border state, and the one or more operational intents.

In one or more embodiments of the present invention, the policy restrains the xApp to update the parameter within a particular range.

In one or more embodiments of the present invention, the xApp is a first xApp, and wherein the policy restrains the first xApp to update the parameter, and does not restrain a second xApp to update the parameter.

According to one or more embodiments of the present invention, a system includes a non-real-time radio access network intelligent controller (non-RT RIC) of a radio access network (RAN). The system further includes multiple near-real-time RAN intelligent controllers (near-RT RICs) of the RAN, the non-RT RIC controls one or more operations of the near-RT RICs, the near-RT RICs comprising a first near-RT RIC and a second near-RT RIC. The first near-RT RIC is configured to receive a module comprising a plurality of instructions to be used for resolving cross-domain conflicts, the first near-RT RIC controls a first domain. The first near-RT RIC is further configured to identify a second near-RT RIC that controls a second domain, wherein an update request from one or more xApps being executed by the first near-RT RIC and the second near-RT RIC has a mutual impact on the first domain and the second domain. The first near-RT RIC is further configured to create a first border state that represents attributes of the first near-RT RIC and the one or more xApps being executed by the first near-RT RIC. The first near-RT RIC is further configured to receive, from the second near-RT RIC, a second border state that represents attributes of the second near-RT RIC and the one or more xApps being executed by the second near-RT RIC. The first near-RT RIC is further configured to generate a policy for the first near-RT RIC by analyzing the first border state and the second border state. The first near-RT RIC is further configured to, based on the policy, in response to receipt of a request from an xApp from the one or more xApps to update a parameter of the RAN: update the parameter based on the policy allowing the xApp to update the parameter; and maintain the parameter unchanged based on the policy restricting the xApp to update the parameter.

According to one or more embodiments of the present invention, a computer program product includes a memory device with computer-executable instructions therein, the computer-executable instructions when executed by a processing unit perform a method for addressing cross-domain conflicts in a radio access network (RAN). The method includes creating on a first near-Real-Time RAN Intelligent Controller (near-RT RIC) an awareness module comprising a plurality of instructions, the first near-RT RIC controls a first domain. The method further includes identifying, by the first near-RT RIC, a second near-RT RIC that controls a second domain, wherein an update request from one or more xApps being executed by the first near-RT RIC and the second near-RT RIC has a mutual impact on the first domain and the second domain. The method further includes creating, by the first near-RT RIC, a first border state that represents attributes of the first near-RT RIC and the one or more xApps being executed by the first near-RT RIC. The method further includes receiving, by the first near-RT RIC from the second near-RT RIC, a second border state that represents attributes of the second near-RT RIC and the one or more xApps being executed by the second near-RT RIC. The method further includes generating, by the first near-RT RIC, a policy for the first near-RT RIC and the second near-RT RIC by analyzing the first border state and the second border state. In response to receiving, by the first near-RT RIC, a request from an xApp from the one or more xApps to update a parameter of the RAN, the parameter is updated based on the policy allowing the xApp to update the parameter, alternatively, the parameter is maintained unchanged based on the policy restricting the xApp to update the parameter.

Embodiments of the invention described herein address technical challenges in computing technology, particularly in fields of telecommunications and computing networks. One or more embodiments of the present invention facilitate improvements to radio access networks (RANs), particularly open-RAN (O-RAN) networks. Embodiments of the present invention provide technical solutions that facilitate automated resolution of inter-domain conflicts without direct involvement of a non-Real-Time RAN Intelligent Controller (non-RT RIC). Embodiments of the present invention facilitate inter-domain operation in O-RAN with direct communication between the near-Real-Time RAN Intelligent Controllers (near-RT RICs), by using one or more of border State Tracking, Border Digital Twin and Activity Register, Cross-domain Policy Generator, and continuous awareness, as described herein. One or more embodiments of the present invention further facilitate creation and maintaining of limited digital twins representing border areas of own domain and neighboring domains. Embodiments of the present invention further facilitate prediction of impact of activities from own domain on the neighboring domain and identification of optimal follow-up actions that prevent negative/unintended network impact. Further, one or more embodiments of the present invention facilitate delegation of decision-making responsibilities from the non-RT RIC to the near-RT RICs.

Embodiments of the present invention improve the O-RAN architecture by reducing response time compared to present techniques to resolve inter-domain conflicts via non-RT RIC, which may not be acceptable as applications demand faster response time for both application and scheduling layer. Further, embodiments of the present invention reduce signaling between the near-RT RICs and the non-RT RIC. Such signaling leads to congestions on A1 interface, especially when control loop utilization tends to surge. Accordingly, embodiments of the present invention prevent such signaling load. Additional advantages and improvements will be evident based on the description herein.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings.

FIG. 1 depicts an architecture of a hierarchically distributed programmable network according to one or more embodiments of the present invention;

FIG. 2 depicts a block diagram of the near-real-time radio access network (RAN) Intelligent Controller (non-RT RIC) according to one or more embodiments of the present invention;

FIG. 3 depicts a border state data structure used by a non-RT RIC to track records according to one or more embodiments of the present invention;

FIG. 4 depicts a visualization of border digital twins stored by each near-RT RICs in one or more embodiments of the present invention;

FIG. 5 depicts a data flow diagram of the utilization of instructions from the non-RT RIC according to one or more embodiments of the present invention;

FIG. 6 depicts a flowchart of a method to detect and/or mitigate cross-domain conflicts at lower-level control entities according to one or more embodiments of the present invention;

FIG. 7 depicts another flowchart of a method to detect and/or mitigate cross-domain conflicts at lower-level control entities according to one or more embodiments of the present invention;

FIG. 8 depicts a sequence diagram to detect and/or mitigate cross-domain conflicts at lower-level control entities according to one or more embodiments of the present invention;

FIG. 9 depicts an operation flow for inter-domain conflict resolution by near-RT RICs according to one or more embodiments of the present invention; and

FIG. 10 depicts a computing environment in accordance with one or more embodiments of the present invention.

The diagrams depicted herein are illustrative. There can be many variations to the diagrams, or the operations described therein without departing from the spirit of the invention. For instance, the actions can be performed in a differing order, or actions can be added, deleted, or modified. Also, the term “coupled,” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three-digit reference numbers. With minor exceptions, the leftmost digit(s) of each reference number corresponds to the figure in which its element is first illustrated.

### DETAILED DESCRIPTION

The description herein makes reference to the Third Generation Partnership Project (3GPP) system, the O-RAN Fronthaul Working Group, and the xRAN Fronthaul Working Group. The description herein uses abbreviations, terms, and technology defined in accord with 3GPP technology standards, O-RAN Fronthaul Working Group technology standards, and xRAN Fronthaul Working Group technology standards. As such, the 3GPP, O-RAN Fronthaul Working Group, and xRAN Fronthaul Working Group technical specifications (TS) and technical reports (TR) referenced herein are incorporated by reference in their entirety herein and define the related terms and architecture reference models that follow. References may also be made to CPRI, the Industry Initiative for a Common Public Radio Interface, and abbreviations, terms, and technology defined in the eCPRI technology standard may also be used consistent with 3GPP technology standards. The CPRI technical specification eCPRI specifications (e.g., V1.1 (2018 Jan. 10)) are also incorporated by reference in its entirety herein.

Embodiments of the invention described herein address technical challenges in computing technology, particularly in the fields of telecommunications and computing networks. One or more embodiments of the present invention facilitate improvements to radio access networks (RANs), particularly open-RAN (O-RAN) networks. Embodiments of the present invention provide technical solutions that facilitate automated resolution of inter-domain conflicts without the involvement of a non-Real-Time RAN Intelligent Controller (non-RT RIC). Embodiments of the present invention facilitate inter-domain operation in O-RAN with direct communication between the near-Real-Time RAN Intelligent Controllers (near-RT RICs) by using one or more of border state tracking, border digital twin and activity register, cross-domain policy generator, and awareness module, as described herein. One or more embodiments of the present invention further facilitate the creation and maintaining of limited digital twins representing border areas of own domain and neighboring domains. Embodiments of the present invention further facilitate predicting the impact of activities from own domain on the neighboring domain and identifying optimal follow-up actions that prevent negative/unintended network impact. Further, one or more embodiments of the present invention facilitate delegating decision-making responsibilities from the non-RT RIC to the near-RT RICs.

Embodiments of the present invention improve the O-RAN architecture by reducing response time compared to present techniques to resolve inter-domain conflicts via non-RT RIC, which may not be acceptable as applications demand faster response time for both the application and scheduling layer. Further, embodiments of the present invention reduce signaling between the near-RT RICs and the non-RT RIC. Such signaling leads to congestion on the A1 interface, especially when control loop utilization tends to surge. Accordingly, embodiments of the present invention prevent such congestion. Additional advantages and improvements will be evident based on the description herein.

Conventional RANs were built employing a single unit that processed the entirety of communication protocols for the RAN. The RAN network traditionally used application specific hardware for processing, making them difficult to upgrade and evolve. However, communication networks and needs evolved with the growing need to support increased capacity. Accordingly, there were (and still are) efforts to reduce RAN deployment costs and improve RAN equipment's scalability and upgradeability. Cloud-based Radio Access Networks (CRAN) are networks where a significant portion of the RAN layer processing is performed at a centralized/central unit (CU), sometimes also referred to as a baseband unit (BBU). Typically, the CU is located in the cloud on commercial off-the-shelf servers, while the RF and real-time critical functions are processed in a remote radio unit (RU or RRU) and a distributed unit (DU). In some embodiments, the DU can be part of the CU/BBU, depending on the functional split.

CRAN provides centralization and virtualization of RAN, with improvements over the earlier architecture of RAN. Such improvements include reduction in operating cost (e.g., because of resource pooling, enabling economies of scale, etc.), improvement in performance improvements (e.g., improved interference), remote upgradeability and management, and improved configurability of features (e.g., transition from 4G to 5G networks).

By using distributed cloud technology, CRAN ensures flexibility and scalability of the network and opens up the possibility to support modern end-user services, such as virtual reality, V2X, remote surgery, and many more, that have much stricter service level agreement (SLA) requirements compared to the legacy services. Operation processes in modern networks are automated because they are to occur at a sub-second time scale. The state-of-the-art networks must be able to support different use cases with various SLA requirements at the same time, e.g., high throughput, ultra-low latency, better signal quality, etc. In this respect, the technical challenges posed to modern networks include at least the following: optimize network utilization by scheduling resource allocations and implementing self-optimization rules at a sub-second time scale; and act swiftly on dynamic network conditions, such as traffic bursts or traffic shifts, to ensure the SLA for all the active services.

Automated network operations for self-decision making have become an essential and inevitable part of the overall network design. Indeed, modern network architectures integrate operation processes in their overall design and, as a result, include network infrastructure that is used to commute user traffic. The footprint of this infrastructure is increased compared to the legacy networks, which is driven by the increase in the network traffic amount and strict SLA requirements of the novel services. Further, modern network infrastructure has been improved to host automated operations processes. This infrastructure must be installed in the proximity of the end-users, and it must be redundant and fail-safe. Compared to the legacy networks, the amount of infrastructure for operations is significantly increased.

As a result, the overall network infrastructure in modern networks is significantly increased compared to legacy networks. O-RAN is one such example of a state-of-the-art modern network. Besides network infrastructure that is used to carry the user traffic in O-RAN (hosting RUs, O-DUs, and O-CUs, small cells, etc.), telecommunication operators have to introduce additional extensive network infrastructure to host the non-RT RICs and several near-RT RICs for faster decision-making control loops.

Broadly, an O-RAN is a nonproprietary version of a CRAN system that allows interoperation between network equipment provided by different vendors. The O-RAN alliance issues specifications and standards that the vendors are required to facilitate the operation of an O-RAN system.

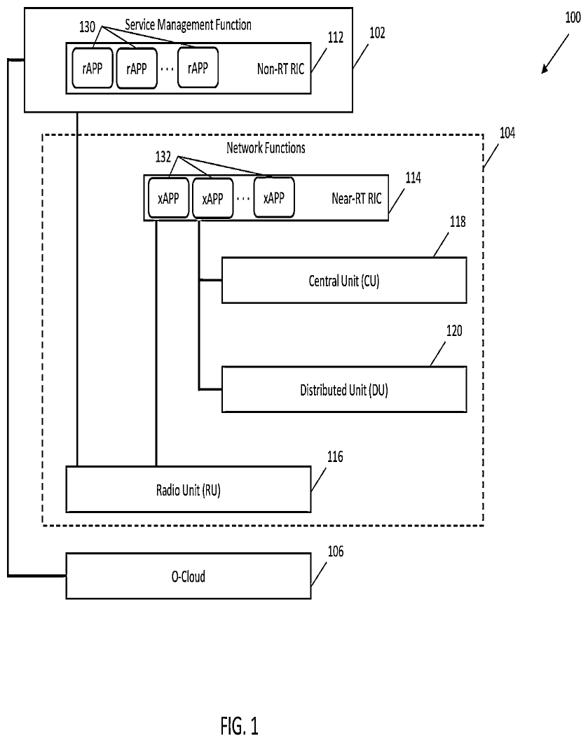

A brief description of an O-RAN architecture is now described with reference to FIG. 1. It is understood that other embodiments of the present invention can use different, fewer, or additional components than depicted herein without diverging from the technical solutions described herein. In some embodiments of the present invention, one or more components depicted herein may be combined or further split (distributed), again without diverting from the technical solutions described herein.

The O-RAN architecture 100 includes several components that inter-communicate over different interfaces. Each interface uses a different name per the O-RAN specification and includes the A1 interface, the O1 interface, the O2 interface, and the Open Fronthaul Management (M)-plane interface. The interfaces connect the Service Management and Orchestration (SMO) framework 102 to O-RAN network functions (NFs) 104. The NFs 104 include, for example, near-RT RICs 114, radio units 116, and other components. The interfaces also connect the SMO 102 and the O-Cloud 106. The O-Cloud 106 can be a cloud computing platform including a collection of physical infrastructure nodes to host the relevant O-RAN network functions (e.g., the near-RT RIC 114, O-CU 118, O-DU 120), supporting software components (e.g., operating systems, virtual machines, container runtime engines, machine learning engines, etc.), and appropriate management and orchestration functions. It should be noted that the SMO 102 and the other components shown can connect with other components (e.g., an enrichment data source, NG-CORE, etc.) that are not depicted herein.

The SMO 102 includes the non-RT RIC 112, which connects with the near-RT RIC 114, for example, via the A1 interface. The SMO 102 can also connect with one or more of the NFs 104. The O-RAN NFs 104 can be virtual network functions (VNFs) such as virtual machines or containers, implemented above the O-Cloud 106 layer and/or above one or more Physical Network Functions (PNFs). The O-RAN NFs 104 may be implemented using customized hardware; however, all the O-RAN NFs 104 support the O1 interface when interfacing with the SMO framework 102.

Further, the SMO 102 manages the O-RAN Radio Unit (O-RU) 116 via the Open Fronthaul M-plane interface. The Open Fronthaul M-plane interface is an optional interface that is included for backward compatibility purposes in particular modes, such as the hybrid mode, as defined in O-RAN specifications.

Conventionally, the SMO 102 with the non-RT RIC 112 and the O-Cloud 106 are referred to as the “management portion/side” of the O-RAN 100; and the near-RT RIC 114, the O-DU 120, the O-RU 116, the O-CU 118 functions are referred to as “radio portion/side” of the O-RAN architecture 100. In some embodiments of the invention, the radio portion/side also includes the gNB (not shown). The gNB 410 is an LTE eNB, a 5G gNB or ng-eNB that supports the E2 interface.

The O-RU 116 is a logical node hosting lower PHY layer entities/elements (Low-PHY layer) (e.g., FFT/iFFT, PRACH extraction, etc.) and RF processing elements based on a lower layer functional split. Virtualization of O-RU 116 is FFS. The O-CU 118 is a logical node hosting the RRC and the control plane (CP) part of the PDCP protocol. The O-CU 118 also hosts the user plane part of the PDCP protocol and the SDAP protocol. The O-DU 120 is a logical node hosting RLC, MAC, and higher PHY layer entities/elements (High-PHY layers) based on a lower-layer functional split. Conventionally, the O-CU 118 and the O-DU 120 are referred to as “E2” nodes because the near-RT RIC 114 connects with them via the E2 interface. In some cases, the gNB may also be included as an E2 node for the same reasons. The protocols over the E2 interface are based exclusively on Control Plane (CP) protocols. The E2 functions are grouped into the following categories: near-RT RIC services (REPORT, INSERT, CONTROL, and POLICY); near-RT RIC support functions, which include E2 Interface Management (E2 Setup, E2 Reset, Reporting of General Error Situations, etc.); and near-RT RIC Service Update (e.g., capability exchange related to the list of E2 Node functions exposed over E2).

In one or more embodiments of the present invention, the Uu interface is used between a UE (not shown), the gNB, and any other O-RAN components. The Uu interface is a 3GPP defined interface, which includes a complete protocol stack from L1 to L3. While only single components are shown herein, it is understood that the O-RAN 100 can include several UEs and/or several gNB, each of which may be connected to one another via respective Uu interfaces. Also, while not shown, the O-RAN architecture 100 can include other interfaces (E1, F1-c, NG-c, X2-c, etc.) that connect the components to other components (that are not shown, e.g., en-gNB, gNB-CU, etc.) and/or to components that are shown.

The non-RT RIC 112 is a logical function within the SMO framework 102 that enables non-real-time (>1 second operation times) control and optimization of RAN elements and resources; AI/machine learning (ML) workflow(s), including model training, inferences, and updates; and policy-based guidance of applications/features in the near-RT RIC 114. In some embodiments of the present invention, the non-RT RIC 112 can be an ML training host to host the training of one or more ML models. ML training can be performed offline using data collected from the near-RT RIC, O-DU 120, and O-RU 116. The near-RT RIC 114 is a logical function that enables near-real-time (sub 1 second operation times) control and optimization of RAN elements and resources via fine-grained data collection and actions over the E2 interface. The near-RT RIC 114 may include one or more AI/ML workflows, including model training, inferences, and updates.

O-RAN is built on the foundation of virtualization, automation, and cloud technologies. NFs 104 are disaggregated, and there are open interfaces between them. To be able to support modern services, O-RAN integrates automated operations into its overall architecture by providing three control loops of different time scales for different operation and optimization processes. The non-real-time control loop (involving the non-RT RIC 112 in SMO 102) has an above-second timeframe, the near-real time control loop (involving the near-RT RICs 114) has a sub-second timeframe, and finally, the real-time control loop (involving the O-DU 120) has the timeframe that is below 10 ms.

The cloud-native nature of the NFs 104 in the O-RAN allows various deployment options, in which some or all functionalities can be bundled together as per the infrastructure availability and operator deployment preference. For more details regarding deployment options, one should refer to the Technical Specification document “O-RAN Architecture Description” from O-RAN WG1. Any O-RAN deployment scenario must ensure that the timing requirements of each of the three control loops are met.

O-RAN specifications further characterize the interfaces into a control plane, a management plane, a synchronization plane, and a user plane. Control Plane (C-plane) refers to real-time control between O-DU 120 and O-RU 106, not including the IQ sample data (part of the User Plane). Management Plane (M-plane) refers to non-real-time management operations between the O-DU 120 and the O-RU 106. Synchronization Plane (S-Plane) refers to traffic between the O-RU 106 or O-DU 120 to a synchronization controller, which is generally an IEEE-1588 Grand Master. Grandmaster not only represents a highly accurate source of synchronization for all network devices supporting the Precision Time Protocol (PTP), the Network Time Protocol (NTP), and the Simple Network Time Protocol (SNTP), etc., but it also offers a number of legacy time and frequency outputs for keeping non-networked devices in-sync. User Plane refers to IQ sample data transferred between O-DU 120 and O-RU 106.

The C-and-U-plane Ethernet stack commonly uses a UDP (User Datagram Protocol) to carry eCPRI or RoE. If RoE is selected, it is carried over Ethernet L2 with a VLAN; eCPRI can be carried over Ethernet L2 or UDP. The C- and U-plane both have the highest priority via the VLAN (priority 7), and within the IP layer are defined as Expedited Forwarding.

The S-plane Ethernet stack uses Ethernet to carry PTP (Precision Time Protocol) and/or SyncE (Synchronous Ethernet) traffic, so that end mobile elements are time-synchronized. In 5G networks, for example, it is particularly important that each RU, especially RUs in the same segment or adjoining segments (locations where UE (User Equipment) may be in contact with multiple RUs), is time-synchronized, allowing the 5G network to maintain high throughput while downloading data from multiple RUs at once, or while transferring from one RU to another.

The M-plane Ethernet stack uses TCP (Transmission Control Protocol) to carry the management messages between the RU 106 and DU 120. O-RAN defines a NETCONF/YANG profile to be carried over this layer via SSH (Secure Shell), allowing communication between the RU 106 and DU 120.

The O-RAN 100 can be used by several users that can represent one or more user equipment, which can be of any type. For example, the users include IoT enabling devices (e.g., sensors, etc.), automated devices (e.g., factory appliances, home appliances, automated vehicles, etc.), user devices (e.g., phones, tablets, laptops, servers, etc.), or any other types of electronic devices that use the O-RAN 100 for communication. The components of O-RAN 100 use one or more hardware equipment, which can include computer servers, modems, routers, switches, computing devices, and any other hardware devices used to implement a networking infrastructure. The hardware devices may implement one or more components of the O-RAN 100 (see FIG. 1) as virtual machines, software developed network modules, machine learning modules, or any other combination thereof.

In O-RAN 100, SMO 102, non-RT RIC 112, and near-RT RICs 104 continuously collect the network state. The RICs (102, 104) host applications (130, 132) that read the network state and govern the network behavior accordingly. These applications include rApps 130 on the non-RT RIC 112 and xApps 132 on near-RT RICS 104, respectively.

rApps 130, which reside in the centralized non-RT RIC 112, are used for identifying network governing policies that require insight into the end-to-end network state or exhaustive computing resources for their calculation. Such attributes, policies, and insights are available only on the non-RT RIC 112. In some embodiments of the present invention, rApps 130 require end-to-end network insight for its operation. rApps 130 issue high-level policies and send them to the entities in the lower hierarchical layer (e.g., near-RT RICs) for interpretation and implementation on radio units 116.

On the other hand, xApps 132 reside on the near-RT RICs 104 and are distributed. Typically, the xApps 132 are those applications that need to operate at timescales of less than a second. Instead, due to their proximity to the network entities (CUs 118, DUs 120, etc.), near-Real Time RICs 104 are used to host the xApps 132 that identify and enforce delay-sensitive optimization policies that require insight in the domain state only. Accordingly, xApps 132 operate leveraging the near-real time control loop that is executed in under 1 s, whereas, for rApps 130, this time can be above 1 s.

The near-RT RICs 104 are placed in the lower hierarchical layer compared to the non-RT RIC 112. Each near-RT RIC 114 has an overview of only its own controlled domains. The near-RT RICs 104 host xApps 132. xApps 132 may not require end-to-end network insight for operation but only insight into the domain state. xApps 132 may implement the policies issued by the rApps 130 or run independently from rApps 130.

There are various types of xApps 132. For example, a first type of xApps 132 can subscribe to rApps 130 and implement the policies that the rApps 130 issue over the interface A1. Second type of xApps 132 can execute independently from rApps 130 and govern the network behavior according to their own logic. xApps 132 execute in parallel with each other, and conflicts can occur. Such conflicts can cause network instability or performance degradation. Conflicts also cause a security risk in O-RAN 100 because attackers may use such a conflict as a vulnerability to attack the network.

O-RAN Alliance has specified the following conflict types between the xApps 132. Direct conflict: Different xApps 132 request to modify the same parameter (e.g., first xApp 132 requests increased antenna downtilt, and second xApp 132 requests a decrease in the antenna downtilt). Indirect conflict: Different xApps 132 request to modify different parameters, but modifying the parameters can have opposing effects (e.g., first xApp 132 requests as antenna down tilt, and a second xApp 132 requests a power increase). Implicit conflict: Different xApps request to modify different parameters, which may not have opposing effects but may cause the overall performance of the network to degrade.

An example of an implicit conflict includes when a first xAPP 132 requests a change to load balancing threshold to push the traffic from its domain, while a second xApp 132 requests reducing the codec rate for accommodating traffic in its domain. Accordingly, the changes are not affecting similar KPIs in both domains. Instead, one domain is pushing the traffic while the other is degrading the customer experience by downgrading the codec rate, thus posing an implicit conflict. It is understood that the examples of direct, indirect, and implicit conflicts herein are for illustration and that there are several other scenarios in which such conflicts can occur. As such, the examples herein are not to be construed as limiting scenarios.

A technical challenge exists to detect and mitigate such conflicts in the O-RAN 100. Typically, direct and (some) indirect conflicts can be detected by leveraging pre-action resolution, in which the near-RT RIC 114 checks the parameters that certain xApp 132 is attempting to modify before the update is implemented in the network. In some cases, post-action verification is performed, in which the near-RT RIC 114 monitors the state of the network after the update has been implemented and verifies if the state is as expected. Implicit conflicts are not always easy to detect. State-of-the-art telecommunications today does not have formal mechanisms for identifying all indirect and implicit conflicts. Even further, O-RAN Alliance currently does not define any interaction between two or more near-RT RICs 104. Accordingly, a first near-RT RIC 114, which has a first domain, is not able to detect a conflict that may be caused in or by a second near-RT RIC 114, which has its separate second domain.

Therefore, a technical challenge exists that coordination and execution of any cross-domain activity in O-RAN 100 (e.g., resolution of inter-domain conflicts) requires the involvement of the non-RT RIC 112 because the near-RT RICs 104 do not directly communicate. The consequence is increased response time, which may not be acceptable as applications demand faster response time for both the application and scheduling layer. Another disadvantage of the inability to resolve cross-domain (or inter-domain) conflict and handle cross-domain coordination leads to increased signaling between the near-RT RICs 104 and the non-RT RIC 112 has to be performed, which may lead to congestion on the A1 interface. Such congestion can be especially experienced in the scenarios when control loop utilization tends to surge for one or more applications.

From the domain point of view, a cross-domain or an inter-domain conflict is one in which conflicting xApps 132 reside on two (or more) different near-RT RICs 114, i.e., actions performed in one domain 201 have consequences in another domain 201 that conflict with policies specified for that domain 201. Herein, such near-RT RICs 114, where a first xApp 132 from a first near-RT RIC 114 can affect policies of a second near-RT RIC 114, are referred to as “neighboring near-RT RICs.”

Cross-domain conflicts can be caused by an action such as Cell Coverage Optimization (CCO) in Domain A vs. CCO in Domain B. Cross-domain conflict can also be caused by a Mobility Load Balancing (MLB) vs. Mobility Robustness Optimization (MRO). Inter-mobility handover function (IMHO) vs. Interference mitigation function can also cause a cross-domain conflict.

Embodiments of the present invention address such technical challenges regarding inter-domain conflicts in O-RAN 100 by using a direct communication link between neighboring near-RT RICs 104. Note that the direct communication in the case when the two near-RT RICs/xAPP/E2 Nodes come from different NEPs may require additional adaptation layer(s). Further, one or more embodiments of the present invention facilitate creating and maintaining limited intended digital twins representing border areas of own domain and neighboring domains. Further, embodiments of the present invention facilitate the prediction of the impact of activities from the own domain on the neighboring domain and the identification of optimal follow-up actions that prevent negative impact. One or more embodiments of the present invention further facilitate the delegation of decision-making responsibilities from the non-RT RIC 112 to the near-RT RICs 104.

At present, inter-domain conflict management in O-RAN 100 is performed by the non-RT RIC 112. Embodiments of the present invention facilitate a comparatively faster inter-domain conflict resolution and inter-domain operation coordination that operates in the lower hierarchical layer of the O-RAN architecture, namely in the near-RT RIC s 104.

Accordingly, embodiments of the present invention improve O-RAN architectures, such as the O-RAN architecture 100. Embodiments of the present invention, accordingly, are rooted in computing technology and facilitates improvement to computing technology, particularly communication networks using O-RAN architecture. Such improvements include detecting and mitigating inter-domain conflicts, such as conflicts between a first near-RT RIC 114 and a second near-RT RIC in the O-RAN architecture. Additional improvements provided by embodiments of the present invention include mitigating congestion on the A1 interface. Further, embodiments of the present invention provide a practical application in the field of computing technology, particularly O-RAN, by establishing a direct communication link between two or more near-RT RICs 104 to resolve inter-domain conflicts and perform other coordination.

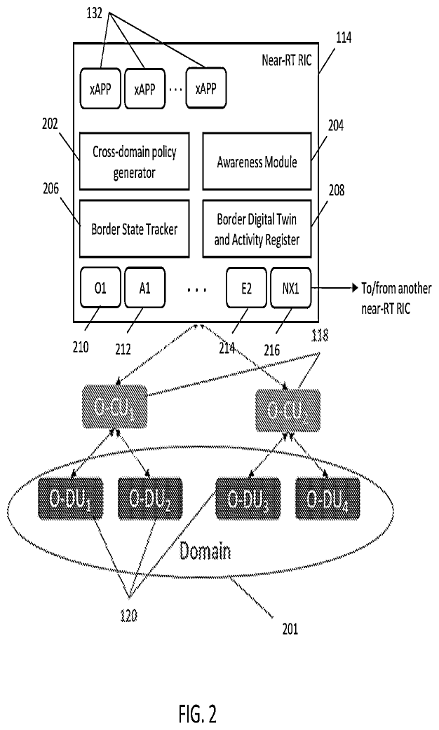

FIG. 2 depicts a block diagram of the near-RT RIC 114 according to one or more embodiments of the present invention. The near-RT RIC 114 is depicted executing N xApps 132, N being any integer. Several functions performed by the near-RT RIC 114 are depicted as blocks; however, it is understood that at least some of these blocks can be combined. Each of the depicted blocks can be a separate module or component, such as a hardware unit (e.g., FPGA, ASIC, etc.) or a software unit (e.g., computer program, application program interface, library, etc.), or a combination thereof.

The near-RT RIC 114 is associated with a domain 201, which includes a set of DUs 120 that is in communication with the near-RT RIC 114. Typically, a DU 120 only communicates with a single near-RT RIC 114 when using the O-RAN 100 (until it is switched to a different near-RT RIC 114). The near-RT RIC 114 communicates with the DUs 120 in domain 201 via one or more CUs 118. In other words, a “domain” 201 of a near-RT RIC 114 is a set of DUs 120 that are associated with that near-RT RIC 114. Each near-RT RIC 114 has its own separate domain 201. Herein, the terms domain and near-RT RIC can be used interchangeably.

The near-RT RIC 114 includes, among other components, a cross-domain policy generator 202, an awareness module 204, a border state tracker 206, and a border digital twin and activity register 208.

Further, the near-RT RIC 114 includes several interfaces to communicate with other components of the O-RAN 100. For example, the interfaces include an O1 interface 210, an A1 interface 212, an E2 interface 214, and an NX1 interface 216. The O1 interface 210 and the A1 interface 212 facilitate the non-RT RIC 112 to communicate with the near-RT RIC 114 as per the O-RAN specification. Further, the E2 interface 214 facilitates communication between the near-RT RIC 114 and the E2 nodes (i.e., CU 118, DU 120) as per the O-RAN specifications. The NX1 interface 216 facilitates a direct communication link between two or more near-RT RICs 114.

The direct communication via the NX1 interface, as facilitated by one or more embodiments of the present invention, reduces the need for involving non-RT RIC 112 to resolve inter-domain conflicts, as is described herein. By eliminating the involvement of the non-RT RIC 112, the resolution of the inter-domain conflict and coordination is faster and further eliminates congestion on the A1 interface (of the non-RT RIC 112). Accordingly, embodiments of the present invention facilitate improvements to the near-RT RIC 114, the non-RT RIC 112, and the overall O-RAN 100.

The border state tracker 206 is responsible for creating and maintaining the border digital twin and activity register 208. The border state tracker 206 tracks and logs the conditions that are relevant for the border digital twin, e.g., relevant user and control plane events and conditions. The border state tracker 206 further shares/receives the border digital twin details with/from the neighboring near-RT RIC 114, i.e., neighboring domains.

Tracking and logging such data digitally in a dynamic manner requires a specific format (i.e., data structure) that provides information that can be used for the detection of conditions that demand attention and policy identification. Embodiments of the present invention provide a logging operation and format that address such technical challenges.

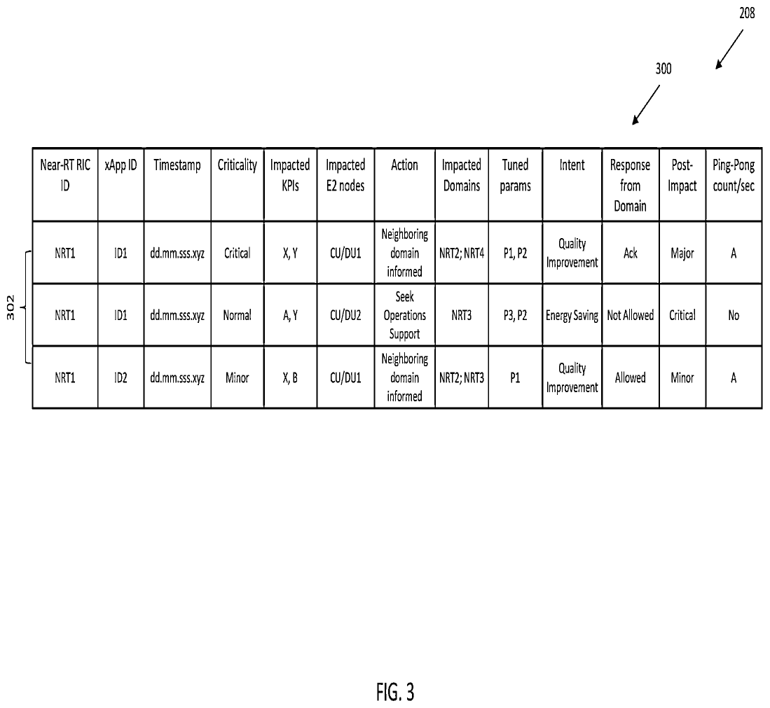

FIG. 3 depicts a border state data structure used by a non-RT RIC 114 to track records according to one or more embodiments of the present invention. The data structure 300 is shown in a tabular format; however, it is understood that the data can be stored using other data structures, such as an array, a graph, etc. Each near-RT RIC 114 stores at least two of the data structures 300: first data structure 300 logs update activity/request sent by the near-RT RIC 114 to a neighboring near-RT RIC 114 (neighbor, second near RT-RIC); and second data structure 300 logs update activity/request received from the neighboring near-RT RIC 114.

Each data structure 300 can include multiple records 302. Each record 302 represents an update activity being performed or an update request being sent by an xApp 132 (of either the near-RT RIC 114 or the neighbor). The update activity/request can be to change one or more parameters of the near-RT RIC 114 and/or any other component of the O-RAN 100.

The record 302 stores information associated with the activity/request. For example, a near-RT RIC ID uniquely identifies the near-RT RIC 114 from which the border affecting update originates. An xApp ID uniquely identifies the xApp 132 that triggered the update. A timestamp is used for logging the time at which the update occurred. A criticality measure is used for logging the operational criticality level that triggered the issued action. The criticality can be predetermined based on the type of update, the timestamp, the parameters being updated, and other such variables related to the state of the near-RT RIC 114 and/or the xApp 132.

Further, record 302 includes impacted KPIs, which are used for logging the KPIs that are targeted to be affected by the action associated with the update. Impacted E2 nodes are used for logging the E2 nodes (118, 120) that are affected by the update. The receiving/neighboring near-RT RIC 114 (i.e., second near-RT RIC) leverages this information to identify the parts of its own domain that can be affected by the update.

The record 302 also logs an action performed with respect to the neighboring near-RT RIC 114 to complete the update. The action received indicates the interaction with the neighboring domain's near-RT RIC 114. The impacted neighboring domains identify the neighboring near-RT RICS 114, of which domains are affected by the issued action.

Tuned parameters list the set of configuration parameters that are affected by the update. In one or more embodiments of the present invention, record 302 also logs the actual change that was enforced in the form of delta value (e.g., “−x” meaning that the value is reduced by x, “+y” meaning that the value is increased for y) or new parameter value (e.g., “x” meaning that the new value of the parameter is x). It is understood that any other format can be used to represent the change being made by the update.

In some embodiments of the present invention, the record 302 logs the high-level intent that triggered the change. The intent can be provided by the xApp 132 requesting the update.

Response from Neighbor is used for logging the response received from the neighboring near-RT RIC 114 to which the update request is sent, e.g., acknowledgment, temporary reject, permanent reject, etc.

The post-implementation impact may also be stored to log the impact that the issued action had on the network. It is represented using the operational criticality level in one or more embodiments of the present invention.

Further, in one or more embodiments of the present invention, a Ping-pong count is stored to indicate if an update is repetitive. The ping-pong count column is used to count the number of occurrences of the same update. It can then be leveraged to detect conflict on the domain border.

It is understood that the above-listed attributes that are logged as the border state can vary in one or more embodiments of the present invention. For example, in some examples, fewer, additional, or different attributes are stored to log information associated with an update activity/request. Further, it is understood that although FIG. 3 only shows three records 302; any number of records can be stored in other examples.

Referring to FIG. 2, the near-RT RIC 114 further includes the border digital twin and activity register 208. The border digital twin that is stored by the near-RT RIC 114 includes information from its own domain and neighboring domain.

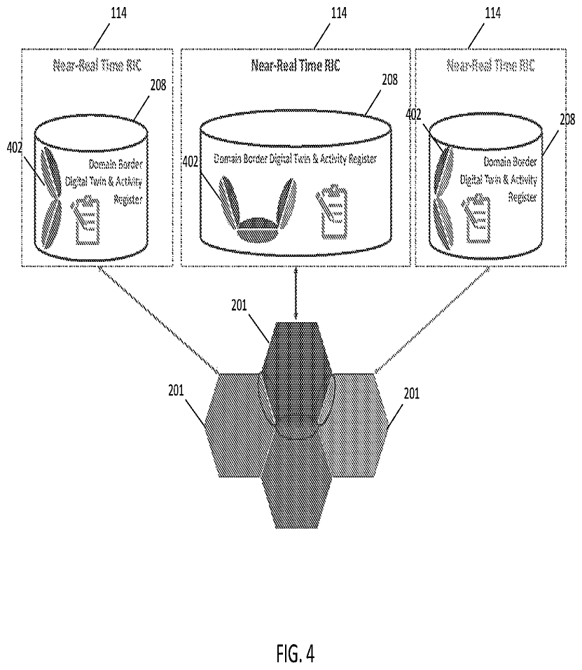

FIG. 4 depicts a visualization of border digital twins 402 stored by each near-RT RICs 114 in one or more embodiments of the present invention. Each near-RT RIC 114 stores a border digital twin 402 that represents a state of one or more neighboring near-RT RICs 114 that affect that near-RT RIC 114 or which are affected by that near-RT RIC 114. The border digital twin 402 is based on information logged (FIG. 3) and other information associated with the near-RT RIC 114.

Each border digital twin 402 includes at least the following information maintained by the Border State tracker 202. The border digital twin 402 at the first near-RT RIC 114 includes information from own (i.e., first near-RT RIC 114) and neighboring domains (i.e., second near-RT RIC 114, third near-RT RIC 114, etc.). While FIG. 4 depicts only three near-RT RICs 114, in other examples, a different number of near-RT RICs 114 can exist. Further, FIG. 4 depicts four domains 201 (three associated with the near-RT RICs 114 depicted, and one shown without a corresponding near-RT RIC); however, in other examples, a different number of domains 201 can exist.

The border digital twin 402 stored at a near-RT RIC 114 records the identities of E2 nodes (118, 120) in their own domain border and E2 nodes (118, 120) in the neighboring domain border. Further, the border digital twin 402 stores information about existing connectivity between E2 nodes (118, 120) belonging to different domains 201. Additionally, the border digital twin 402 includes a configuration snapshot of each E2 node (118, 120) from that border digital twin 402.

In one or more embodiments of the present invention, the border digital twin 402 also includes the profile of users covered by each E2 node from the digital twin. Here, a user profile represents consumer usage type like consumer using high throughput applications, consumers having high mobility at particular time, etc. A user profile can also indicate a consumer categorization like premium user, budget user, etc. Further, present traffic demand from the users covered by each E2 node (118, 120) from the digital twin 402 is also stored. In some examples, a dependency between configuration parameters of E2 nodes (118, 120) in the border digital twin 402 is also stored.

The border digital twin 402 further includes the activity register, which is the log of cross-domain impacting control plane activities, e.g., activities from the xApps 132. An “activity” of an xApp 132 can include any operation executed by the xApp 132, such as an adjustment of a parameter, receipt/transmission of data/command, etc.

In FIG. 4, information corresponding to the different domains 201 stored in the border digital twin 402 is represented with different colors (gray shade). The information can be stored using a data structure such as an array, a graph, a table, a database, etc.

In one or more embodiments of the present invention, the near-RT RIC 114 continuously analyzes the collected information, i.e., border digital twin 402, and identifies conditions that need attention. In one or more embodiments of the present invention, instructions from the awareness module (elaborated below) are used to analyze the border digital twin 402. Analysis of the border digital twin can be rule-based or artificial intelligence/machine learning (AI/ML) based analysis.

If a condition that needs attention is detected, the near-RT RIC 114 can propose actions labeled as “Seek Operations Support” (see FIG. 3), in which the near-RT RIC 114 114 can request, for example, migration of its own E2 nodes to neighboring near-RT RICs 114 for the sake of self-offloading. These actions are written to the Activity Registry and will be shared with the neighboring Near-Real Time RICs by the border state tracker 206. Further, the near-RT RIC 114 can create actionable insight that is consumed by the cross-domain policy generator 202 (elaborated below) for further processing.

In one or more embodiments of the present invention, such analysis and consequent actions can be triggered after each change (insert, modify, or delete) in the border digital twin and activity register 208 by leveraging database triggers where a database management system is used to store the border digital twin and activity register 208.

The awareness module 204 facilitates performing operations in response to one or more instructions/commands from the non-RT RIC 112 and/or other components of the near-RT RIC 114. For example, the awareness module 204 responds to INST1: Border digital twin relevance, which is used for the identification of conditions and events on the user and control plane that must be added to the border digital twin and activity register. For control plane activities (e.g., from xApps 132), the instruction involves the rules for the prediction of potential cross-domain impact. INST1 is leveraged by border activity tracker 206.

Further, the awareness module 204 responds to INST2: Log-based identification of conditions that need attention, which is leveraged to update and maintain the Border Digital Twin and Activity Register.

The awareness module 204 further response to INST3: Condition prioritization and policy identification. For example, conditions/activities that relate to quality of service (QoS) optimization have higher priority than policies for energy saving. Similarly, policies that are triggered by critically impacted E2 nodes are prioritized over policies triggered by E2 nodes with an impact level of major or minor. This information is leveraged by the cross-domain policy generator 202 for operation coordination (elaborated herein) when responding to operations support requests or identifying policy resolution strategies.

Further, the awareness module 204 responds to INST4: Adaptations needed on the NX1 interface, which might be used for communication between two near-RT RICs 114 as RIC/xApp/E2 nodes might have been developed by two different network equipment providers (NEPs). The INST4 response may include parameter conversion, value mapping, etc., performed by the awareness module 204.

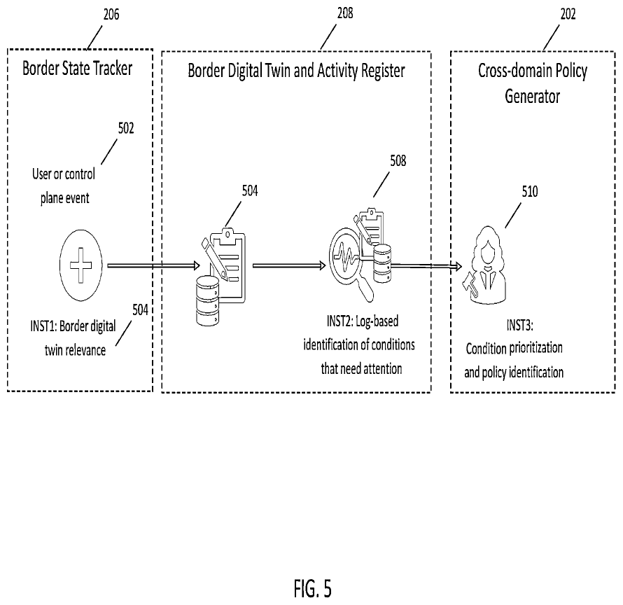

FIG. 5 depicts a data flow diagram of the utilization of instructions from the non-RT RIC 112 according to one or more embodiments of the present invention. At block 502, a user plane or a control plane event occurs (i.e., update request/activity via the xApp 132). At block 504, the near-RT RIC 114 determines whether the event is relevant to the border digital twin at the near-RT RIC 114 using INST1. If the event is relevant, an update to the border digital twin 402 is triggered at block 506.

At block 508, based on the update to the border digital twin 402 and using INST2, conditions of the near-RT RIC 114 (and any neighboring near-RT RICs 114) are identified from the logged data structure 300, which are to be updated. Further, at block 510, a cross-domain condition prioritization and policy identification is performed using INST3.

It is understood that the above sequence of operations is one example and that the instructions listed can be used in several other ways. Further, the names of the instructions used herein can be changed without affecting the functionality provided in one or more embodiments of the present invention.

Referring to FIG. 2, the cross-domain policy generator 202 identifies cross-domain policies when conditions that need attention are identified (e.g., inter-domain conflict detected, operations support requested, etc.). For that purpose, the cross-domain policy generator 202 leverages the instructions INST3 from the awareness module 204. The cross-domain policy generator 202 automatically generates a policy for the near-RT RIC 114. A “policy” is a set of conditions that have to be satisfied before the near-RT RIC 114, or an xApp 132 of the near-RT RIC 114 can perform an operation, and the operation cannot be performed if the condition(s) are not satisfied. The conditions are based on one or more neighboring near-RT RICs 114 in one or more embodiments of the present invention. In one or more embodiments of the present invention, the near-RT RIC 114, upon generating a policy in this manner, shares the policy with one or more neighboring near-RT RICs 114.

For example, a policy may include local xApp guidance in which, for example, the local xApp can be turned off for a certain amount of time, or it can be prevented from updating certain parameters on certain local E2 nodes. In one or more embodiments of the present invention, the policy can be passed to the conflict mitigator for enforcement of the policy. Here, “local” represents in relation to a near-RT RIC 114 that generates the policy. For example, if a first near-RT RIC 114 generates the policy, a local E2 node 118 is in the domain 201 associated with the first near-RT RIC 114.

Alternatively, or in addition, the generated policy can include whether to send ACK (confirm) or NACK (reject) as a response to particular types of requests from a neighboring near-RT RIC 114, for example, operations support requests.

In one or more embodiments of the present invention, conflict resolution action is proposed to the neighboring domain 201 and sent over the direct link (NX1 interface 216) to the neighboring near-RT RIC 114 that controls the neighboring domain 201. The neighboring near-RT RIC has to respond to the proposed action indicating that the action has been applied or rejected.

Conflict resolution actions can include a variety of actions. For example, an action can include a remote xApp to be requested to be turned off for a certain amount of time, or it can be prevented from updating certain parameters on a certain remote E2 node. Here, “remote” represents the neighboring near-RT RIC 114 or domain 201. Alternatively, or in addition, an action can include reconfiguration of the remote E2 node to alleviate the effects of the conflict. A variety of other such actions can be requested of the neighboring near-RT RIC 114 to resolve a cross-domain conflict.

Further, the policy can include informing the non-RT RIC 112 (that controls the near-RT RIC and neighboring near RT-RIC 114) when a cross-domain conflict condition cannot be locally solved. For example, such a condition can arise when the near-RT RIC 114 has conflicting policies from two domains having the same priorities, and criticality or operations support requests cannot be accommodated.

In one or more embodiments of the present invention, the near-RT RIC 114 sends the policy generated to the cross-domain policy generator 202 in the neighboring near-RT RIC 114, which verifies and applies the policy.

A technical challenge that arises is a scenario in which multiple near-RT RICs 114 identify and attempt to resolve the same cross-domain conflict, particularly if each proposes a different conflict resolution policy. The different policies themselves may include steps that can be conflicting, leading to even further disruptions in the deployed O-RAN 100. To address such a technical challenge, in embodiments of the present invention, even if multiple near-RT RICs 114 identify the (same) conflict, only the near-RT RIC 114 from whose domain 201 the conflicting policy with higher priority originated proposes the actions for conflict resolution. In case the conflicting policies have the same priority, then the near-RT RIC 114 may consider existing criticality in domain 201 to take suitable actions. In one or more embodiments of the present invention, domain 201 with critical impact overrides domain 201 with minor impact.

In the case where more than one neighboring domain 201 seeks the same coordinated action, then the timestamp is considered for prioritization of neighboring domain 201. Other domain(s) 201 are sent a request to wait for a predetermined duration to prevent them from continuously sending repeated requests for coordinated actions.

Alternatively, in addition, in case the conflicting policies have the same priority and criticality, which is why the conflict cannot be locally resolved on the near-RT RIC level, then each near-RT RIC 114 reports about it to the non-RT RIC 112. The non-RT RIC 102 identifies that the multiple reports received respectively from the several near-RT RICs 114 all refer to the same conflict occurrence. Such identification is based on the record 302 received, which identifies the near-RT RICs 114 and xApps 132 requesting an action causing the conflict(s). The non-RT RIC 102 is then responsible for identifying and enforcing the cross-domain policy.

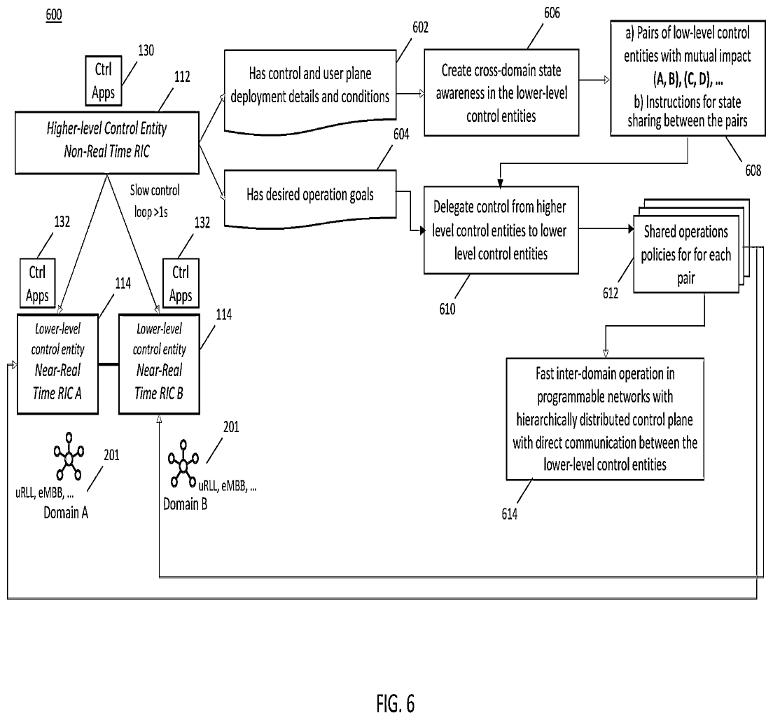

FIG. 6 depicts a flowchart of a method to detect and/or mitigate cross-domain conflicts in an O-RAN at lower-level control entities according to one or more embodiments of the present invention. As noted herein, O-RAN specification and present techniques for resolving a cross-domain conflict, which occurs at lower-level entities of the O-RAN 100 (i.e., near-RT RICs, E2 nodes, etc.) is to use a higher-level entity (i.e., the non-RT RIC 112) to detect and resolve the cross-domain conflict. Such a conflict resolution at the higher-level entity is used because the higher-level entity (non-RT RIC 112) can request and capture control and user plane deployment details and conditions at block 602. Further, the higher-level entity receives the desired operation goals, for example, from one or more administrators, customers, etc., at block 604.

However, one of the technical challenges with such techniques is that the control loop with higher-level entities (e.g., 1 second or higher) is an order of magnitude slower than the control loop of the lower-level entities (sub-millisecond range). Accordingly, conflict resolution is slow, causing disruption in the operation of the lower-level entities. Further, the existing techniques cause congestion because several lower-level entities have to communicate with the higher-level entity to resolve the conflict.

The technical challenges are addressed by method 600 shown. At block 606, at each of the lower-level entities (e.g., near-RT RICs 114), cross-domain state awareness is created, respectively. Further, at block 608, pairs of lower-level entities are identified such that the entities in a pair mutually impact each other by their activities. For example, near-RT RIC A 114 and near-RT RIC B 114 are identified as mutually impacting each other. Further, at block 608, the mutually impacting pair of lower-level entities are provided instructions (e.g., INST-X instructions described herein) for sharing respective states. A “state” of a lower-level entity includes the data structure 300 that specifies attributes of the lower-level entity, including one or more control applications 132 executing on that lower-level entity.

At block 610, the higher-level entity delegates control to resolve cross-domain conflicts (that satisfy certain conditions) to the lower-level entities that are identified and provided with instructions. At block 612, the delegated lower-level entities in the mutually impacting pairs share operation policies determined based on the shared states (data structure 300) with each other. Accordingly, at block 614, the lower-level entities are enabled to resolve cross-domain conflicts with direct communication among themselves without involving the higher-level entity. Thus, the O-RAN 100, which has a hierarchically distributed control plane, is improved to resolve cross-domain conflicts at lower-levels of the control plane at the lower-level itself without affecting the operations of the higher-level entity.

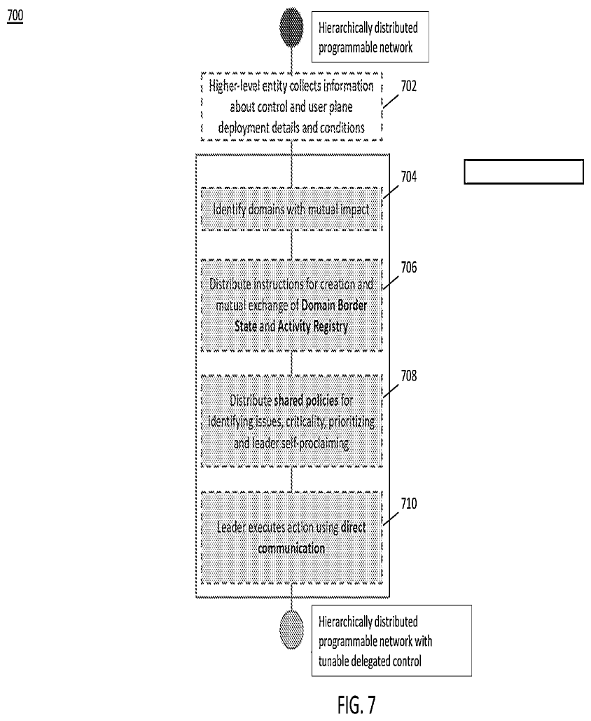

FIG. 7 depicts another flowchart of a method to detect and/or mitigate cross-domain conflicts in an O-RAN at lower-level control entities according to one or more embodiments of the present invention. Method 700 is performed in a hierarchically distributed programmable network, such as the O-RAN 100.

At block 702, the higher-level entity (i.e., non-RT RIC 112) collects information about control and user plane deployment details and conditions. The non-RT RIC 112 captures information about network-wide conditions in several manners. For example, information about the underlying control plane is received over the interface O2. FCAPS-related information about the deployed network functions can be captured over interface O1. (FCAPS is an acronym for fault, configuration, accounting, performance, and security and is a network management framework created by the International Standards Organization (ISO).) Further, information about the user plane conditions is received from all the connected near-RT RICs 114 over the A1 interface. Each near-RT RIC 114 has information about local domain conditions, e.g., about the user and control plane conditions received from the connected E2 nodes, and information about the local hardware on which it is deployed, e.g., CPU usage, available cores, etc.

At block 704, the non-RT RIC 112 identifies domains 201 with mutual impact. The domains with mutual impact are determined using an artificial intelligence/machine learning (AI/ML) model(s) that identifies cross-domain conflict based on the control and user plane data captured over at least a predetermined duration (or a predetermined number of operations). In one or more embodiments of the present invention, conflict detection may identify patterns that indicate conflict occurrence based on the logged data. The AI/ML model(s) are pre-trained using a training dataset before being deployed on the non-RT RIC 112 in one or more embodiments of the present invention. The AI/ML model(s) can be continuously updated as the non-RT RIC 112 is used. In one or more embodiments of the present invention, the trained AI/ML model(s) can detect conflict-related patterns based on different conflict types, i.e., direct, indirect, and implicit. In one or more embodiments of the present invention, only the non-RT RIC 112 detects cross-domain or inter-domain conflicts. Each pair of domains 201 (and corresponding near-RT RICs 114) that has had a cross-domain conflict(s) with each other are identified as the mutually impacting domains/entities.

At block 706, the non-RT RIC 112 delegates control over cross-domain conflicts to a near-RT RIC 114 in an identified pair by creating a cross-domain state awareness module (204) in the near-RT RIC 114. Creating awareness module 204 can include loading a computer program into the near-RT RIC 114. Alternatively, or in addition, creating the awareness module 204 can include enabling the awareness module 204 that is in a dormant or inactive state in the near-RT RIC 114. The creation of the awareness module 204 enables the near-RT RIC 114 to be able to perform several operations corresponding to the several instructions (INST-X) described herein. The awareness module 204 facilitates the creation and maintenance of the domain border state and activity register 208 as described herein using several operations. Each near-RT RIC 114, thus updated, continuously creates, and maintains the domain border state and activity register 208 using the created awareness module 204, at block 706. Further, at block 706, based on the border state and activity register 208, each near-RT RIC 114 generates a cross-domain policy.

At block 708, the first near-RT RIC 114 in an identified pair shares the cross-domain policy thus created with the second near-RT RIC 114 in the pair. The sharing is performed via direct communication on the NX1 interface 216. Each near-RT RIC 114 in the pair compares the received policy from the other. The comparison can be based on metrics such as criticality, post-impact, timestamp, etc. Based on the comparison, each near-RT RIC 114 determines which one of the two near-RT RICs 114 in the pair is to be assigned a leader of that pair. Because the two near-RT RICs 114 are comparing the same two policies, albeit independently, both reach the same result/conclusion. Accordingly, one of the near-RT RICs 114 in the pair assumes the role of the leader of that pair. The leader near-RT RIC 114 uses the cross-domain policy that was created by itself.

At block 710, in case of a cross-domain conflict being detected in the pair, the leader near-RT RIC 114 resolves the cross-domain conflict based on the policy that was generated by itself (i.e., leader near-RT RIC).

Accordingly, the hierarchically distributed programmable network can be improved to have tunable delegated control using method 700. Embodiments of the present invention accordingly improve existing communication network architecture and provide a practical application to resolve cross-domain conflicts in such networks.

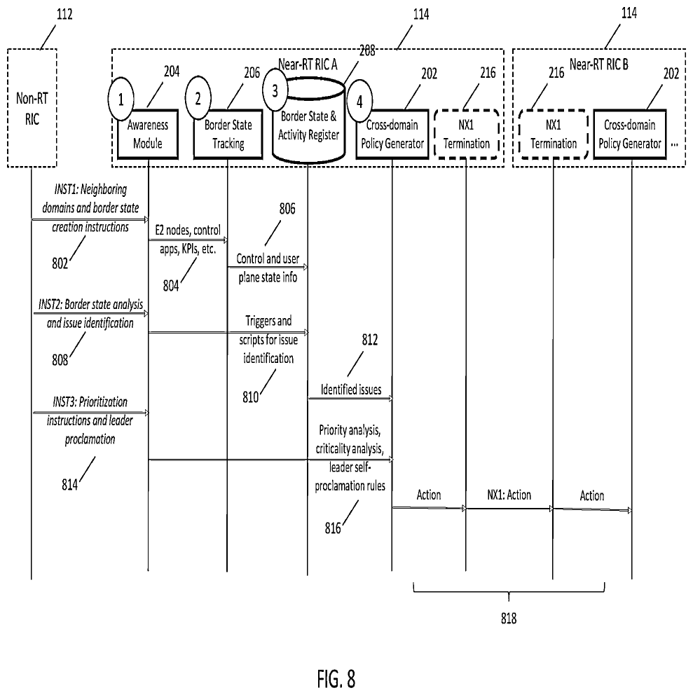

FIG. 8 depicts a sequence diagram to detect and/or mitigate cross-domain conflicts in an O-RAN at lower-level control entities according to one or more embodiments of the present invention. The sequence diagram illustrates the creation and use of the instructions (606, 706) by the non-RT RIC 112 to delegate control to the lower-level entities (near-RT RICs 114) to resolve a cross-domain conflict.

As described herein, the non-RT RIC 112 creates the awareness module 204 in the near-RT RIC A 114 (first near-RT RIC) that is identified to handle cross-domain conflicts with another near-RT RIC B 114 (second near-RT RIC) (802). For example, the non-RT RIC 112 initiates, in the near-RT RICs 114, INST1 used for the creation of neighboring domains and border states. The near-RT RIC A 114, using the awareness module 204, accumulates the border state information, including E2 nodes, KPIs, xApps 132, etc., of the neighboring near-RT RIC B 114 (804). The near-RT RIC A 114 also shares its own border state information with the near-RT RIC B 114.

The border and state tracker 206 creates the border digital twin 402 and updates the border state and activity register 208 based on the control plane and user plane information captured in this manner (806).

The non-RT RIC 112 further triggers INST2 to analyze the border digital twin that is captured to identify potentially mutually impacting domains and cross-domain conflicts (808). The INST2 may trigger one or more scripts to be run at the near-RT RICs A, B 114 to analyze the respectively captured digital twins 401 (810). One or more of the conditions detected by the scripts are forwarded to the cross-domain policy generator 202 (812).

The non-RT RIC 112 triggers INST3 to analyze the generated cross-domain conflict policies to determine prioritization and consequent leader proclamation (814). The near-RT RICs A, B 114 perform a criticality analysis and priority analysis on the policies to compare them (816). As described herein, several other parameters from the border state data structure 300 can be used to break a tiebreaker between the policies. The generated policies are shared among the near-RT RICs A, B 114 using direct communication via the NX1 interface (818).

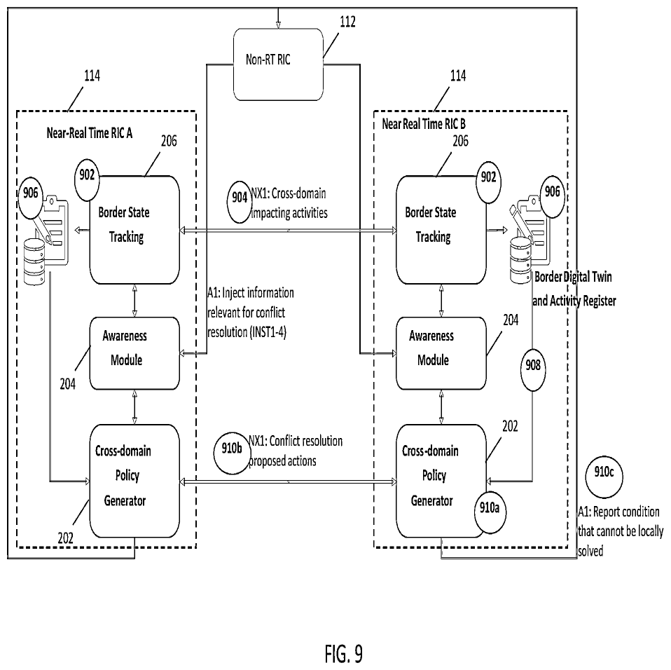

FIG. 9 depicts an operation flow for inter-domain conflict resolution by near-RT RICs according to one or more embodiments of the present invention. The operation flow of FIG. 9 depicts the operations performed by the near-RT RICs A, B 114 to resolve the cross-domain conflict using the techniques described herein.

At block 902, border state tracker 206 logs all local updates and conditions that are relevant for the border digital twin and activity register 208, following instructions obtained from the non-RT RIC 112 (these are stored in the awareness module 204). Both near-RT RICs 114 perform such updates.

At block 904, the border state tracker 206 forwards the captured local conditions and activities that are relevant for the border digital twin and activity register 208 to the near-RT RICs 114 of the neighboring domains. Such communication occurs over the NX1 interface 216.

At 906, the border digital twin and activity register 208 continuously monitors its own data and identifies conditions that require attention by leveraging the instructions from the non-RT RIC 112.

At 908, when the border digital twin and activity register 208 identifies the condition that needs attention, it creates the actionable insight and passes it to the cross-domain policy generator 202 to decide on further steps. Consider the scenario in which the near-RT RIC B 114 identifies the condition, which is a cross-domain conflict in response to an update request from an xApp 132 (local or remote).

At 910, the cross-domain policy generator 202 identifies and performs the necessary steps by leveraging the instructions from the non-RT RIC 112 that are stored in the awareness module 202. The steps performed by the cross-domain policy generator 202 include, at 910a, executing the policy locally. Further, at 910b, the cross-domain policy generator 202 shares the policy with the remote cross-domain policy generator 202. In the case that the cross-domain conflict cannot be locally resolved, at 910c, the cross-domain policy generator 202 reports the condition that needs attention to the non-RT RIC 112.

The non-RT RIC 112 and the near-RT RICs 114 can be computer servers in one or more embodiments of the present invention. In some cases, the computer server can use distributed computing. Alternatively, or in addition, the non-RT RIC 112 and the near-RT RICs 114 can be any other type of computing device, such as a desktop computer, a laptop computer, a portable computer, etc.

Although not explicitly illustrated herein, the non-RT RIC 112 can include several components as per the O-RAN specification or otherwise.

It should be noted that the near-RT RIC 114 includes all of the components as specified by the O-RAN specifications in addition to the one or more components described herein to facilitate the technical solutions herein.

In one or more embodiments of the present invention, operational intents received from the operator are essential for conflict mitigation as they reflect the operator's desires regarding network operation and therefore are used to identify the optimal xApp behavior for each network state. In general, the xApp actions at any time must be such that they maintain satisfactory KPIs or improve the degraded KPIs while keeping intent into consideration. The cross-domain conflict generator 202 is aware of the optimization goals of each xApp 132 and the parameters that each xApp 132 can affect. Only then the cross-domain conflict generator 202 can tune the xApp activity according to the intent requirements.

In one or more embodiments of the present invention, the cross-domain conflict generator 202 uses reinforcement learning to determine the policies.

Reinforcement learning is a subfield of machine learning and is also a general-purpose formalism for automated decision-making and AI. The goal of reinforcement learning is to take suitable action to maximize reward in a particular situation. Reinforcement learning (RL) is not strictly supervised as it does not rely only on a set of labeled training data but is not unsupervised learning because an agent is trained to maximize a reward. The agent needs to find the “right” actions to take in different situations to achieve its overall goal. There are three basic concepts in reinforcement learning: state, action, and reward. The algorithm (agent) evaluates a current situation (state), takes action, and receives feedback (reward) from the environment after each act. Positive feedback is a reward, and negative feedback is a punishment for making a mistake. Markov Property: requires that “the future is independent of the past given the present.” RL relies on the state transition probability, which indicates, given a present state, what is the probability the next state will occur. Further, in RL, all state transitions can be defined in terms of a State Transition Matrix P, where each row provides the transition probabilities from one state to all possible successor states. When an agent is transitioned from the current state to the next state, it is either rewarded positively or negatively based on the actions of the agent following a particular policy.

For example, the cross-domain conflict generator 202 can generate a policy: xApp1 may update param1 to val1 or val2 on E2 node CU/DU1, xApp2 must be blocked from changing param2 but can change param3 on the CU/DU1 and CU/DU2.

Cross-domain conflict generator 202 leverages the policies when responding to E2 guidance request that causes an update to one or more xApps 132. For example, in the above policy example, if xApp2 attempts to update the param2 on the E2 node CU/DU1, the cross-domain conflict generator 202 responds with rejection. On the other hand, the cross-domain conflict generator 202 does not block xApp2 from making changes on the param3 on the same E2 node.

In one or more embodiments of the present invention, the cross-domain conflict generator 202 is able to record the instructions received in the individual policies and retrieve these when xApps 132 call E2 guidance requests and verify the requested xApp activity.

The technical solutions described herein improve the O-RAN 100 and provides a practical application to detect and mitigate cross-domain (inter-domain) conflicts at a lower-level, i.e., by the near-RT RICs. It is understood that one or more of the described operations can be performed in parallel and/or in sequence.

It should be noted that the non-RT RIC 112 and near-RT RIC 114 include several other components (such as interface termination modules, databases, shared data layers, messaging infrastructures, etc.) than depicted in the drawings herein. Only the relevant components are depicted and described herein. Also, in O-RAN, each network function 104 is deployed as a container. Here, “containers” are executable units of software in which application code is packaged, along with its libraries and dependencies, in common ways so that it can be run anywhere, whether it be on a desktop, traditional IT, or the cloud. It should be noted that containers, unlike virtual machines, do not need to include a guest OS in every instance and can, instead, simply leverage the features and resources of the host OS. Further, non-RT RIC 112 captures information about network-wide conditions in several manners. For example, information about the underlying cloud infrastructure is received over the interface O2. FCAPS-related information about the deployed network functions can be captured over interface O1. Further, information about the user plane conditions is received from all the connected near-RT RICs 114 over the A1 interface. Each near-RT RIC 114 has information about local domain conditions, e.g., about the user and control plane conditions received from the connected E2 nodes, and information about the local hardware on which it is deployed, e.g., CPU usage, available cores, etc.

Embodiments of the present invention facilitate detection, resolution, and mitigation of inter-domain conflicts in programmable networks with hierarchically organized operation planes. Embodiments of the present invention facilitate resolving such inter-domain conflicts at a lower-level of the hierarchical network. Log correlation and pattern detection are incorporated for collecting the stateful activity logs from neighbouring lower-level entities and aggregating these logs to detect the patterns that assist in creating policies to resolve cross-domain conflicts at the lower-level entities themselves without involving the higher-level entity. Here, lower-level entities include near-RT RICs, and higher-level entity includes non-RT RICs.

Embodiments of the present invention facilitate control applications communications for coordination & conflict management in a hierarchical programmable network, while higher-level entity in the hierarchy governs the policy. Embodiments of the present invention improve the existing O-RAN architecture by facilitating coordination and execution of cross-domain impacting activities without the involvement of the higher-level entity, i.e., non-RT RIC, and establishing a direct communication link between the lower-level entities, i.e., near-RT RICs impacted by the cross-domain conflict. Embodiments of the present invention facilitate reduced response time, thus enabling the use of applications that require faster response time for both the application and scheduling layer. Further, embodiments of the present invention mitigate signaling congestion between the near-RT RICs and the non-RT RIC on the A1 interface, especially when control loop utilization tends to surge for applications demanding reduced response times.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

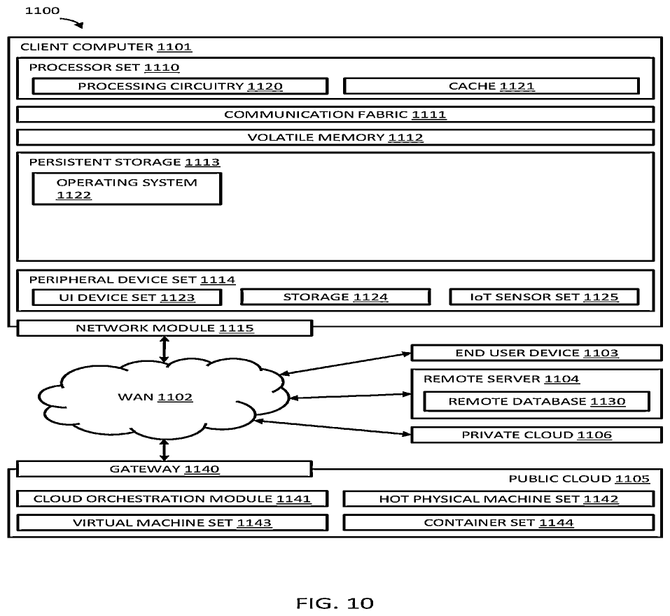

FIG. 10 depicts a computing environment in accordance with one or more embodiments of the present invention. Computing environment 1100 contains an example of an environment for the execution of at least some of the computer code involved in performing the inventive methods, such as optimal compression of machine learning model 800. In addition to block 800, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smartwatch or other wearable computer, mainframe computer, quantum computer or any other form of computer or mobile device now known or to be developed in the future that is capable of running a program, accessing a network, or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 800 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 800 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The present invention can be a system, a method, and/or a computer program product at any possible technical detail level of integration. The computer program product can include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for addressing cross-domain conflicts in a radio access network (RAN), the computer-implemented method comprising:
creating on a first near-Real-Time RAN Intelligent Controller (near-RT RIC) an awareness module comprising a plurality of instructions, the first near-RT RIC controls a first domain;
identifying, by the first near-RT RIC, a second near-RT RIC that controls a second domain, wherein an update request from one or more xApps being executed by the first near-RT RIC and the second near-RT RIC has a mutual impact on the first domain and the second domain;
creating, by the first near-RT RIC, a first border state that represents attributes of the first near-RT RIC and the one or more xApps being executed by the first near-RT RIC;
receiving, by the first near-RT RIC from the second near-RT RIC, a second border state that represents attributes of the second near-RT RIC and the one or more xApps being executed by the second near-RT RIC;
generating, by the first near-RT RIC, a policy for the first near-RT RIC and the second near-RT RIC by analyzing the first border state and the second border state; and
in response to receiving, by the first near-RT RIC, a request from an xApp from the one or more xApps to update a parameter of the RAN:
updating the parameter based on the policy allowing the xApp to update the parameter; and
maintaining the parameter unchanged based on the policy restricting the xApp to update the parameter.

2. The computer-implemented method of claim 1, wherein the awareness module is created on the near-RT RIC by a non-Real-Time RAN Intelligent Controller (non-RT RIC).

3. The computer-implemented method of claim 1, wherein the first near-RT RIC generates the policy using machine learning.

4. The computer-implemented method of claim 1, wherein the first near-RT RIC updates the first border state in response to each action taken by any of the one or more xApps.

5. The computer-implemented method of claim 1, wherein the first near-RT RIC and the second near-RT RIC communicate with each other via a communication link without using the non-RT RIC.

6. The computer-implemented method of claim 1, wherein the first near-RT RIC sends the policy to the second near-RT RIC to cause the second near-RT RIC, in response to the request from the xApp from the one or more xApps to update the parameter of the RAN:
update the parameter based on the policy allowing the xApp to update the parameter; and
maintain the parameter unchanged based on the policy restricting the xApp to update the parameter.

7. The computer-implemented method of claim 5, wherein the policy is a first policy, and wherein second near-RT RIC compares the first policy with a second policy generated by the second near-RT RIC based on one or more of prioritization and criticality.

8. The computer-implemented method of claim 1, further comprising:
receiving, by the first near-RT RIC, one or more operational intents that specify desired operating ranges for one or more performance indicators; and
wherein, the policy is generated based on the first border state, the second border state, and the one or more operational intents.

9. The computer-implemented method of claim 1, wherein the policy restrains the xApp to update the parameter within a particular range.

10. The computer-implemented method of claim 1, wherein the xApp is a first xApp, and wherein the policy restrains the first xApp to update the parameter, and does not restrain a second xApp to update the parameter.

11. A system comprising:
a non-real-time radio access network intelligent controller (non-RT RIC) of a radio access network (RAN); and
a plurality of near-real-time RAN intelligent controllers (near-RT RICs) of the RAN, the non-RT RIC controls one or more operations of the near-RT RICs, the near-RT RICs comprising a first near-RT RIC and a second near-RT RIC;
wherein the first near-RT RIC is configured to:
receive a module comprising a plurality of instructions to be used for resolving cross-domain conflicts, the first near-RT RIC controls a first domain;
identify a second near-RT RIC that controls a second domain, wherein an update request from one or more xApps being executed by the first near-RT RIC and the second near-RT RIC has a mutual impact on the first domain and the second domain;
create a first border state that represents attributes of the first near-RT RIC and the one or more xApps being executed by the first near-RT RIC;
receive, from the second near-RT RIC, a second border state that represents attributes of the second near-RT RIC and the one or more xApps being executed by the second near-RT RIC;
generate a policy for the first near-RT RIC by analyzing the first border state and the second border state; and
based on the policy, in response to receipt of a request from an xApp from the one or more xApps to update a parameter of the RAN:
update the parameter based on the policy allowing the xApp to update the parameter; and
maintain the parameter unchanged based on the policy restricting the xApp to update the parameter.

12. The system of claim 11, wherein the module is received from a non-Real-Time RAN Intelligent Controller (non-RT RIC).

13. The system of claim 11, wherein the first near-RT RIC and the second near-RT RIC communicate with each other via a communication link without using the non-RT RIC.

14. The system of claim 11, wherein the first near-RT RIC is configured to send the policy to the second near-RT RIC to cause the second near-RT RIC, in response to the request from the xApp from the one or more xApps to update the parameter of the RAN:
update the parameter based on the policy allowing the xApp to update the parameter; and
maintain the parameter unchanged based on the policy restricting the xApp to update the parameter.

15. The system of claim 14, wherein the policy is a first policy, and wherein second near-RT RIC compares the first policy with a second policy generated by the second near-RT RIC based on one or more of prioritization and criticality.

16. The system of claim 11, wherein the first near-RT RIC is further configured to:
receive one or more operational intents that specify desired operating ranges for one or more performance indicators, wherein, the policy is generated based on the first border state, the second border state, and the one or more operational intents.

17. A computer program product comprising a memory device with computer-executable instructions therein, the computer-executable instructions when executed by a processing unit perform a method for addressing cross-domain conflicts in a radio access network (RAN), the method comprising:
creating on a first near-Real-Time RAN Intelligent Controller (near-RT RIC) an awareness module comprising a plurality of instructions, the first near-RT RIC controls a first domain;
identifying, by the first near-RT RIC, a second near-RT RIC that controls a second domain, wherein an update request from one or more xApps being executed by the first near-RT RIC and the second near-RT RIC has a mutual impact on the first domain and the second domain;
creating, by the first near-RT RIC, a first border state that represents attributes of the first near-RT RIC and the one or more xApps being executed by the first near-RT RIC;
receiving, by the first near-RT RIC from the second near-RT RIC, a second border state that represents attributes of the second near-RT RIC and the one or more xApps being executed by the second near-RT RIC;
generating, by the first near-RT RIC, a policy for the first near-RT RIC and the second near-RT RIC by analyzing the first border state and the second border state; and
in response to receiving, by the first near-RT RIC, a request from an xApp from the one or more xApps to update a parameter of the RAN:
updating the parameter based on the policy allowing the xApp to update the parameter; and
maintaining the parameter unchanged based on the policy restricting the xApp to update the parameter.

18. The computer program product of claim 17, wherein the awareness module is created on the near-RT RIC by a non-Real-Time RAN Intelligent Controller (non-RT RIC).

19. The computer program product of claim 17, wherein the first near-RT RIC and the second near-RT RIC communicate with each other via a communication link without using the non-RT RIC.

20. The computer program product of claim 17, wherein the first near-RT RIC sends the policy to the second near-RT RIC to cause the second near-RT RIC, in response to the request from the xApp from the one or more xApps to update the parameter of the RAN:
update the parameter based on the policy allowing the xApp to update the parameter; and
maintain the parameter unchanged based on the policy restricting the xApp to update the parameter.
